(19) United States
(12) Patent Application Publication
(10) Pub. No.: US 2026/0296329 A1
(43) Pub. Date: Oct. 1, 2026

(54) VEHICLE-MOUNTED DISPLAY DEVICE AND STATE SWITCHING METHOD THEREFOR

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Yue Lei, Beijing (CN); Junhuan Liu, Beijing (CN); Hong Zhu, Beijing (CN); Yue Cui, Beijing (CN)

(73) Assignees: CHENGDU BOE OPTOELECTRONICS TECHNOLOGY CO., LTD., Chengdu, Sichuan (CN); BOE TECHNOLOGY GROUP CO., LTD., Beijing (CN)

(21) Appl. No.: 19/479,490

(22) PCT Filed: Sep. 4, 2024
(86) PCT No.: PCT/CN2024/116920

§ 371 Date: Oct. 28, 2025

(30) Foreign Application Priority Data
Dec. 22, 2023 (CN) 202311789818.1

(51) Int. Cl. B60R 11/02; B60R 11/00

(52) U.S. Cl. CPC B60R 11/0229; B60R 2011/0005; B60R 2011/0075; B60R 2011/0082; B60R 2011/0084; B60R 2011/0092

(57) ABSTRACT

The present application provides a vehicle-mounted display device, including: a flexible display portion; a first motion portion and a second motion portion, respectively connected to two sides of the flexible display portion, and a plane where the first motion portion is located intersects with a plane where the second motion portion is located; a tensioning structure arranged between the first motion portion and the second motion portion; and a driving device configured to drive the first motion portion to move prior to the second motion portion in a first driving state, so that the first motion portion drives the second motion portion to move through the flexible display portion; drive the second motion portion to move prior to the first motion portion through the tensioning structure in a second driving state, so that the second motion portion drives the first motion portion to move through the flexible display portion.

### CROSS-REFERENCE TO RELATED APPLICATION

The present application claims priority to Chinese Patent Application No. 202311789818.1, entitled “VEHICLE-MOUNTED DISPLAY DEVICE AND STATE SWITCHING METHOD THEREFOR”, filed on Dec. 22, 2023, to China National Intellectual Property Administration, the entire contents of which are incorporated herein by reference.

### FIELD

The present application relates to the technical field of displays, in particular to a vehicle-mounted display device and a state switching method thereof.

### BACKGROUND

In the technical field of display, flexible display modules have characteristics of light and thin volume and strong bending flexibility, thereby broadening structural forms of terminal devices, and the terminal devices have made breakthroughs in applications such as vehicle display.

As a new form of vehicle-mounted display, an L-shaped vehicle-mounted lifting display device may realize a change of proportions of two screens, and a display surface of the display device may form a certain angle with a horizontal plane. When the device is in a descending state, an upper and rear functional modules may be exposed for use, and when the device is in an ascending state, the upper and rear functional modules may be blocked, thus achieving a purpose of saving space.

### SUMMARY

The present application aims to provide a vehicle-mounted display device and a state switching method therefor.

A first aspect of the present application provides a vehicle-mounted display device, including:
a flexible display portion;
a first motion portion and a second motion portion, wherein the first motion portion and the second motion portion are respectively connected to two sides of the flexible display portion, and a plane where the first motion portion is located intersects with a plane where the second motion portion is located;
a tensioning structure arranged between the first motion portion and the second motion portion; and
a driving device configured to drive the first motion portion and the second motion portion to move relatively;
wherein the driving device is configured to:
in a first driving state, drive the first motion portion to move prior to the second motion portion, so that the first motion portion drives the second motion portion to move through the flexible display portion; and
in a second driving state, drive the second motion portion to move prior to the first motion portion through the tensioning structure, so that the second motion portion drives the first motion portion to move through the flexible display portion.

Optionally, the driving device includes a driving unit and a sliding block arranged on the driving unit, and a driving reversing block is arranged on the sliding block;
the driving unit is configured to drive the sliding block and the driving reversing block to move in a first direction;
the driving device further includes a first driving portion and a second driving portion that are connected to each other, wherein the first driving portion is connected to the first motion portion, and the second driving portion is connected to the tensioning structure;
wherein, in the first driving state, the driving unit drives the sliding block so that the driving reversing block contacts the first driving portion and disengages from the second driving portion; and
in the second driving state, the driving unit drives the sliding block so that the driving reversing block contacts the second driving portion and disengages from the first driving portion.

Optionally, the driving reversing block includes a first contact portion and a second contact portion;
the first driving portion is provided with a first groove, the second driving portion is provided with a second groove, the first contact portion is located in the first groove, and the second contact portion is located in the second groove;
wherein, in the first driving state, the driving unit drives the sliding block so that the first contact portion contacts an inner wall of the first groove and the second contact portion disengages from an inner wall of the second groove; and
in the second driving state, the driving unit drives the sliding block so that the second contact portion contacts the inner wall of the second groove and the first contact portion disengages from the inner wall of the first groove.

Optionally, the driving unit includes a fixed sliding groove and a motor arranged at one end of the fixed sliding groove;
the fixed sliding groove extends along the first direction, and an output end of the motor is provided with a lead screw, and the lead screw is located in the fixed sliding groove and extends along a length direction of the fixed sliding groove; and
the sliding block is slidably connected in the fixed sliding groove, and the sliding block is threadedly engaged with the lead screw.

Optionally, the vehicle-mounted display device further includes:
a mounting portion, including a first fixing portion and a second fixing portion that are connected to each other; wherein
the first motion portion is slidably connected to the first fixing portion along the first direction, and the second motion portion is slidably connected to the second fixing portion along a second direction;
the first direction and the second direction are perpendicular to each other.

Optionally, a side of the second fixing portion away from the second motion portion is rotatably connected to a plurality of support shafts, and the flexible display portion contacts the plurality of support shafts.

Optionally, the tensioning structure includes at least two groups of tensioning members;
each of the tensioning members includes a first reversing roller, a second reversing roller, a third reversing roller and a tensioning belt, wherein the first reversing roller is arranged on the first fixing portion, the second reversing roller is arranged on the second fixing portion, the third reversing roller is rotatably arranged on a support shaft of the plurality of support shafts, one end of the tensioning belt is fixedly connected to the first motion portion, and the tensioning belt sequentially bypasses the first reversing roller, the third reversing roller and the second reversing roller, and is fixed connected to the second motion portion.

Optionally, a material of the tension belt includes polyimide.

Optionally, the support shaft is fixedly connected to a plurality of sleeve shafts, diameters of the plurality of sleeve shafts are larger than a diameter of the third reversing roller, the flexible display portion contacts the plurality of sleeve shafts, and the third reversing roller is independent of the plurality of sleeve shafts.

Optionally, two ends of the third reversing roller are provided with second bearings, the second bearings are sleeved on the support shaft, and the support shaft is provided with limit clamp springs at both ends of the third reversing roller.

Optionally, the first fixing portion is provided with bearing mounting seats at both sides of the first reversing roller, and first bearings are fixedly arranged on the bearing mounting seats, and the first reversing roller is rotatably connected to the bearing mounting seats through the first bearings;
a fourth reversing roller is further arranged between the bearing mounting seats, and the tension belt is sequentially wound around the first reversing roller and the fourth reversing roller.

Optionally, the tensioning member further includes a movable roller, the movable roller is arranged on the first motion portion, and the tensioning belt is wound around the movable roller.

Optionally, the tensioning member further includes a fixing member arranged at an end of the tensioning belt and the fixing member is configured to connect the end of the tensioning belt to the first motion portion or the second motion portion.

Optionally, the first fixing portion is provided with two guide rails on both sides of the first motion portion, and the guide rails extend along the first direction, and both sides of the first motion portion are respectively slidably connected in the two guide rails.

Optionally, the second fixing portion includes a plurality of first comb teeth, and a first accommodating groove is formed between two adjacent first comb teeth;
the second motion portion includes a plurality of second comb teeth, and a second accommodating groove is formed between two adjacent second comb teeth;
the first comb teeth are slidably connected in the second accommodating groove, and the second comb teeth are slidably connected in the first accommodating groove.

Optionally, the first comb teeth are provided with a plurality of mounting grooves, and magnetic members are arranged in the plurality of mounting grooves.

Optionally, the plurality of mounting groove are configured as a strip shape and extend along the second direction.

18. The vehicle-mounted display device according to any one of claims 5 to 17, wherein the vehicle-mounted display device further includes:
an accommodating structure, wherein the mounting portion, the driving device and the tensioning structure are all located in the accommodating structure.

Optionally, the vehicle-mounted display device further includes:
a control unit, connected to the driving device and configured to control the driving device to switch to the first driving state or the second driving state.

Optionally, the vehicle-mounted display device further includes:
a display unit, connected to the flexible display portion and configured to control the flexible display portion to emit light.

A second aspect of the present application provides a state switching method for the vehicle-mounted display device, including:
receiving a state switching instruction;
in response to an indication of the state switching instruction, switching states of the flexible display portion from an ascending state to a descending state, and driving the first motion portion to move prior to the second motion portion by the driving device, so that the first motion portion drives the second motion portion to move through the flexible display portion;
in response to the indication of the state switching instruction, switching the states of the flexible display portion from the descending state to the ascending state, and driving the second motion portion to move prior to the first motion portion through the tensioning structure, so that the second motion portion drives the first motion portion to move through the flexible display portion.

The above description is only an overview of the technical solution of the present disclosure. In order to have a clearer understanding of the technical solution of the present disclosure, it can be implemented in accordance with the content of the specification. Moreover, in order to make the above and other purposes, features and advantages of the present disclosure more obvious and understandable, the specific implementation methods of the present disclosure are hereby listed.

### BRIEF DESCRIPTION OF THE DRAWINGS

In order to explain the technical solutions of the embodiments of the present application more clearly, the drawings needed in description of the embodiments of the present application will be briefly introduced below. Obviously, the drawings in the following description are only some embodiments of the present application. For persons skilled in the art, other drawings may be obtained according to these drawings without paying creative labor.

FIG. 1 is a schematic structural diagram of a vehicle-mounted display device in a descending state according to an embodiment of the present application;

FIG. 2 is a schematic structural diagram of a vehicle-mounted display device in an ascending state according to an embodiment of the present application;

FIG. 3 is a schematic diagram of an explosion structure of a vehicle-mounted display device according to an embodiment of the present application;

FIG. 4 is a schematic structural diagram of a support unit in a vehicle-mounted display device according to an embodiment of the present application;

FIG. 5 is a schematic diagram of a support unit, a driving device and a tensioning structure in a vehicle-mounted display device according to an embodiment of the present application;

FIG. 6 is a schematic structural diagram of a driving device in a vehicle-mounted display device according to an embodiment of the present application;

FIG. 7 is a schematic diagram of a driving principle of a driving device in a vehicle-mounted display device according to an embodiment of the present application;

FIG. 8 is a schematic structural diagram of a contact between a first contact portion and an inner wall of a first groove in a vehicle-mounted display device according to an embodiment of the present application;

FIG. 9 is a schematic structural view of contact between a second contact portion and an inner wall of a second groove in a vehicle-mounted display device according to an embodiment of the present application;

FIG. 10 is a schematic diagram of a principle of a tensioning member of a vehicle-mounted display device in a descending state according to an embodiment of the present application;

FIG. 11 is a schematic diagram of a principle of a tensioning member of a vehicle-mounted display device in an ascending state according to an embodiment of the present application;

FIG. 12 is a schematic structural diagram of a first reversing roller in a vehicle-mounted display device according to an embodiment of the present application;

FIG. 13 is a schematic structural diagram of a second reversing roller in a vehicle-mounted display device according to an embodiment of the present application;

FIG. 14 is a schematic structural diagram of a third reversing roller in a vehicle-mounted display device according to an embodiment of the present application;

FIG. 15 is a schematic diagram of a principle of a tensioning member of a vehicle-mounted display device in a descending state and including a movable roller according to an embodiment of the present application;

FIG. 16 is a schematic diagram of a principle of a tensioning member of a vehicle-mounted display device in an ascending state and including a movable roller according to an embodiment of the present application; and

FIG. 17 is a structural schematic diagram of a fixing member of a tensioning member in a vehicle-mounted display device according to an embodiment of the present application.

### DETAILED DESCRIPTION

In the following, the technical solution in the embodiments of the present application will be clearly and completely described with reference to the drawings in the embodiments of the present application. Obviously, the described embodiments are a portion of the embodiments of the present application, but not all embodiments. Based on the embodiments in the present application, all other embodiments obtained by persons skilled in the art without creative work belong to the protection scope of the present application.

In the related art, a display screen of an L-shaped vehicle-mounted display device usually has two states including an ascending state and a descending state, wherein, the ascending state refers to a state in which the display screen is completely exposed, and the descending state refers to a state in which the display screen is partially exposed, and a switching between these two states is generally realized by a driving unit in the vehicle-mounted display device, and the driving unit may drive one side of the display screen to move, and keep the display screen tensioned all the time by using a tensioning structure, to realize the switching of the states of the display screen.

When the driving unit drives one side of the display screen to move away from a position where the driving unit is located, the other side of the display screen will drive the display screen to realize state switching under an action of the tensioning structure. However, at this time, a stressed side of the display screen (that is, the side where the driving unit is located) will be additionally stressed by a driving unit, which will cause the display screen to arch at a position of a rolling shaft, that is, the display screen will not contact a supporting portion behind it, which will affect the use of the vehicle-mounted display device.

In view of this, the embodiment of the present application proposes a vehicle-mounted display device. By arranging a flexible display portion, a first motion portion and a second motion portion, a tensioning structure is arranged between the first motion portion and the second motion portion, wherein the first motion portion and the second motion portion are connected to both sides of the flexible display portion respectively, and the first motion portion and the second motion portion may move relatively; Then the driving device is used to drive the first motion portion to move prior to the second motion portion, so that the first motion portion drives the second motion portion to move through the flexible display portion; Or, the driving device drives the second motion portion to move prior to the first motion portion through the tensioning structure, so that the second motion portion drives the first motion portion to move through the flexible display portion; In this way, the flexible display portion may always keep exerting pressure on the rolling shaft when switching, thereby reducing phenomenon that the flexible display portion arches at the position of the rolling shaft and improving user experience.

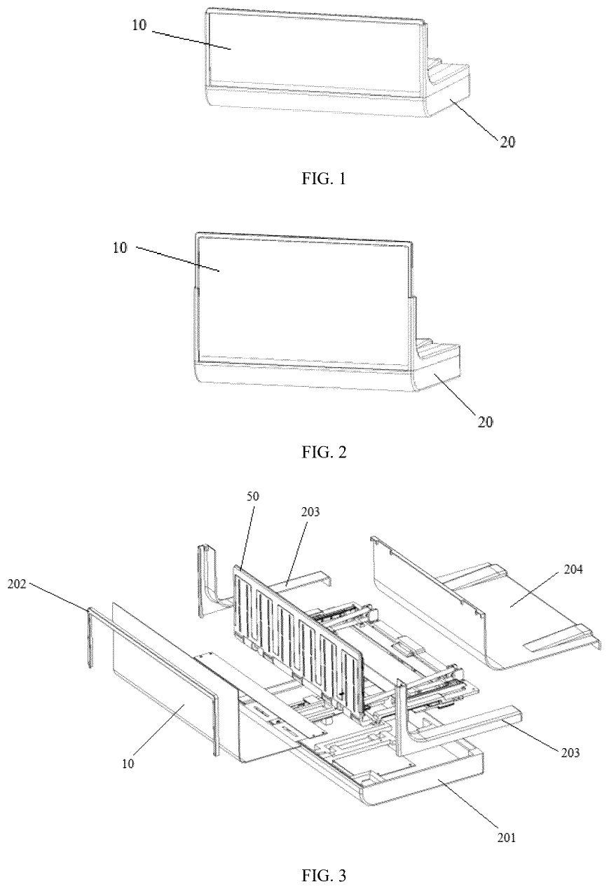

Referring to FIG. 1, FIG. 2 and FIG. 3, a vehicle-mounted display device disclosed in an embodiment of the present application includes a flexible display portion 10, a support unit 50 configured to support the flexible display portion 10, a driving device 40 (not shown in the figure) configured to drive the flexible display portion 10 to switch states, and an accommodating structure 20.

Specifically, the accommodating structure 20 is mainly configured to accommodate relevant structures of the vehicle-mounted display device, and protect and hide these structures. For example, both the support unit 50 and the driving device 40 may be located in the accommodating structure 20, but at least portion of the flexible display portion 10 is located outside the accommodating structure 20 for displaying images. In this embodiment, the accommodating structure 20 may include a box body 201, a front frame 202, a side frame 203 and a rear frame 204, and both the support unit 50 and the driving device 40 of the vehicle-mounted display device may be placed in the box body 201; The front frame 202 may cover the side frame of the flexible display portion 10 for protection. The main functions of the side frame 203 and the rear frame 204 are to cover the whole vehicle-mounted display device for protection. Obviously, the accommodating structure 20 may also be a portion of a dashboard on a vehicle.

The flexible display portion 10 is a flexible display module with a display function, and for example, the flexible display portion 10 may be an OLED (Organic Light-Emitting Diode) display module. Referring to FIG. 1 and FIG. 2, the flexible display section 10 has two states, an ascending state and a descending state. When the flexible display portion 10 is in the descending state, only a portion of the flexible display portion 10 (for example, one third of a size of an area of the flexible display portion 10) is located outside the accommodating structure 20 to display images. When the flexible display portion 10 is in the ascending state, a whole flexible display portion 10 is located outside the accommodating structure 20 to display images, that is to say, the flexible display portion 10 in the ascending state has more display area than the flexible display portion 10 in the descending state. Obviously, the flexible display portion 10 in the ascending state may also display more image contents than the flexible display portion 10 in the descending state.

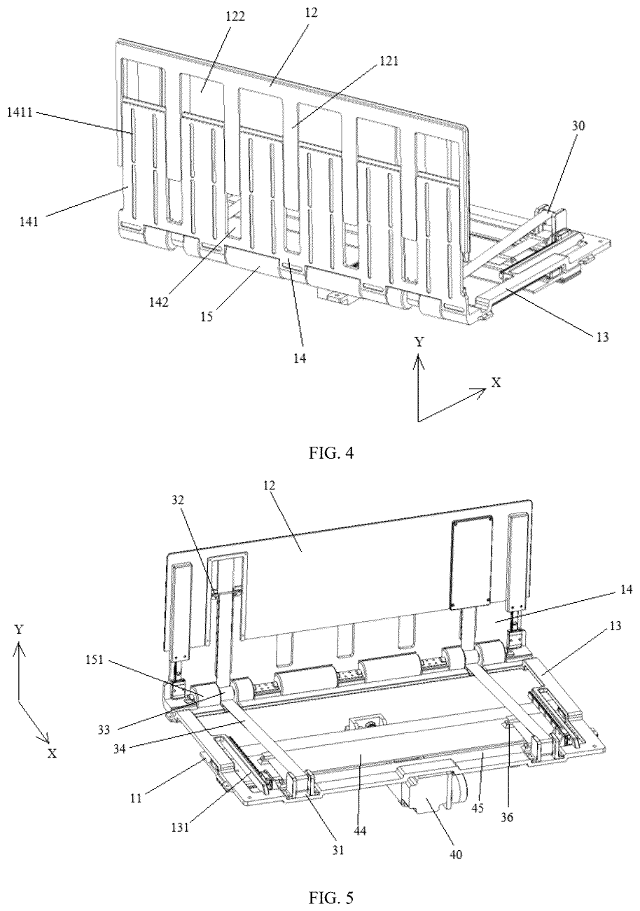

Referring to FIG. 3, FIG. 4 and FIG. 5, the support unit 50 includes a mounting portion, a first motion portion 11 and a second motion portion 12. Among them, the mounting portion includes a first fixing portion 13 and a second fixing portion 14, and the first fixing portion 13 and the second fixing portion 14 are connected to each other, and a plane where the first fixing portion 13 is located intersects with a plane where the second fixing portion 14 is located. That is, the first fixing portion 13 and the second fixing portion 14 form a certain included angle, and the included angle may be 60°, 75°, 90°, 105°, 120° and so on. In this embodiment, the first fixing portion 13 and the second fixing portion 14 are perpendicular to each other.

Meanwhile, the first motion portion 11 is slidably connected to the first fixing portion 13 along a first direction X, and the second motion portion 12 is slidably connected to the second fixing portion 14 along a second direction Y. The first direction X and the second direction Y are perpendicular to each other, that is, a plane where the first motion portion 11 is located and a plane where the second motion portion 12 is located are also perpendicular to each other. Obviously, when the first fixing portion 13 and the second fixing portion 14 are in a non-perpendicular state, the first motion portion 11 and the second motion portion 12 are also in a non-perpendicular state. In addition, in the embodiment of the present application, in order to facilitate movement of the first motion portion 11, the first fixing portion 13 is arranged in a hollow frame structure, and the first motion portion 11 is slidably connected to the first fixing portion 13 at a position of frame of the first fixing portion 13, so that large-area contact between the first motion portion 11 and the first fixing portion 13 may be avoided, which is more conducive to the movement of the first motion portion 11; The second fixing portion 14 is arranged in a plate structure, and the flexible display portion 10 is attached to a plate surface of the second fixing portion 14, which may make the flexible display portion 10 more flat (and also improve back support for the flexible display portion 10), thus ensuring display effect of the flexible display portion 10.

Both sides of the flexible display portion 10 are connected to the first motion portion 11 and the second motion portion 12, respectively, and the flexible display portion 10 and the second fixing portion 14 remain attached. It can be understood that the first motion portion 11 and the second motion portion 12 may move relatively. For example, when the flexible display portion 10 switches from a descending state to an ascending state, the first motion portion 11 will move towards the position where the second fixing portion 14 is located, and the second motion portion 12 will move away from the position where the second fixing portion 14 is located, so that the flexible display portion 10 hidden in the accommodating structure 20 is exposed and display. When the flexible display portion 10 switches from the ascending state to the descending state, the first motion portion 11 will move away from the position where the second fixing portion 14 is located, and the second motion portion 12 will move close to the position where the second fixing portion 14 is located, so that the portion of the flexible display portion 10 is hidden in the accommodating structure 20 again.

In addition, as shown in FIG. 4, the second fixing portion 14 is provided with a plurality of grooves on a side far away from the second motion portion 12, and support shafts 15 are rotatably connected in these grooves, and the flexible display portion 10 also keeps in contact these support shafts 15, to facilitate the flexible display portion 10 to move better.

A tensioning structure 30 is further provided between the first motion portion 11 and the second motion portion 12. Since only one side of the flexible display portion 10 is usually stressed when switching the states of the flexible display portion 10, in order to make the whole flexible display portion 10 move normally, it is necessary to set the tensioning structure 30 to realize relative movement of the first motion portion 11 and the second motion portion 12. For example, when the first motion portion 11 is stressed, the first motion portion 11 will drive one side of the flexible display portion 10 to move, and at the same time, the first motion portion 11 will make the second motion portion 12 move relatively through the tensioning structure 30, thus making the other side of the flexible display portion 10 move relatively.

The driving device 40 is power source for driving the flexible display portion 10 to change states, that is, the driving device 40 may generate a force on the first motion portion 11 or the second motion portion 12, thereby realizing movement of the flexible display portion 10. For example, when the driving device 40 is connected to the first motion portion 11, the driving device 40 may drive the first motion portion 11 to move in a direction away from the second fixing portion 14, so that the flexible display portion 10 may be switched from an ascending state to a descending state. However, when the driving device 40 drives the first motion portion 11 to move in the direction close to the second fixing portion 14, that is, when the flexible display portion 10 switches from the descending state to the ascending state, the movement of the flexible display portion 10 is completely realized through the tensioning structure 30 at this time, and the flexible display portion 10 will be subjected to an additional force from the driving device 40, resulting in the phenomenon that the flexible display portion 10 arches at the position of the support shaft 15.

In order to reduce the arching phenomenon of the flexible display portion 10, in the embodiment of the present application, the driving device 40 includes a first driving state and a second driving state.

Specifically, in the first driving state, the driving device 40 drives the first motion portion 11 to move prior to the second motion portion 12, that is, the first motion portion 11 directly exerts a force on the flexible display portion 10, and then makes the flexible display portion 10 drive the second motion portion 12 to move. At this time, the tensioning structure 30 will evidently have a certain tensioning effect, however, since the flexible display portion 10 is continuously subjected to pulling force from the first moving portion 11, so that the flexible display portion 10 may consistently exerts pressure on the support shaft 15, thereby reducing the arching phenomenon of the flexible display portion 10. In this embodiment, the flexible display unit 10 transitions from the raised state to the lowered state under the first driving state. In the embodiment of the present application, in the first driving state, the flexible display section 10 is switched from an ascending state to a descending state.

In the second driving state, the driving device 40 drives the second motion portion 12 to move prior to the first motion portion 11 through the tensioning structure 30, that is, the driving device 40 first forces the second motion portion 12 through the tensioning structure 30, then the second motion portion 12 exerts a force on the flexible display portion 10, and then makes the flexible display portion 10 drive the first motion portion 11 to move. In this process, because the second motion portion 12 moves first, therefore, the flexible display portion 10 will always be subjected to pulling force from the second motion portion 12, so that the flexible display portion 10 may always exert pressure on the support shaft 15 and reduce the arching phenomenon of the flexible display portion 10. In the embodiment of the present application, in the second driving state, the flexible display section 10 is switched from a descending state to an ascending state.

In this way, whether the flexible display portion 10 is switched from the ascending state to the descending state or from the descending state to the ascending state, it may always exert pressure on the support shaft 15, thereby reducing the arching phenomenon of the flexible display portion 10.

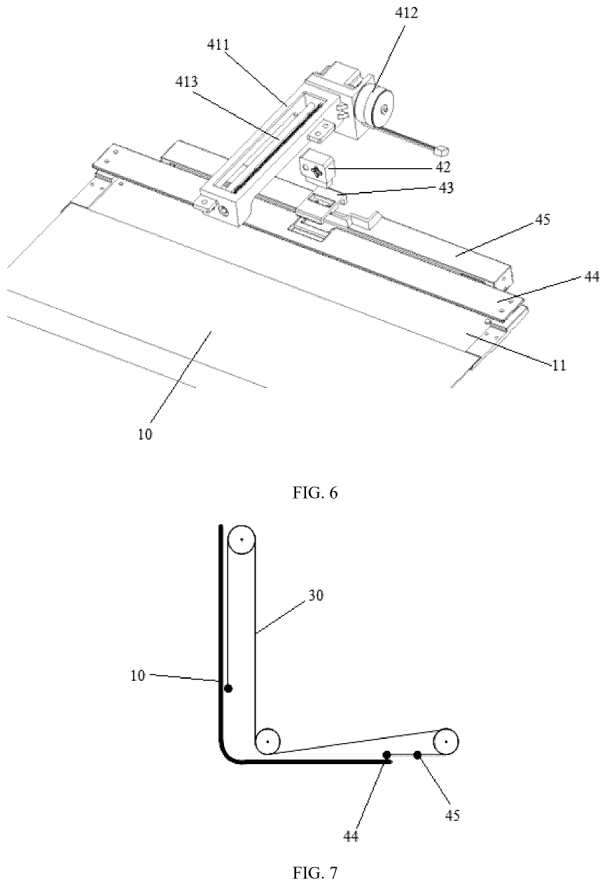

Specifically, referring to FIG. 6, the driving device 40 includes a driving unit 41 and a sliding block 42 arranged on the driving unit 41, and a driving reversing block 43 is arranged on the sliding block 42, and the driving unit 41 may drive the sliding block 42 and the driving reversing block 43 to move in a first direction X. Meanwhile, the driving device 40 further includes a first driving portion 44 and a second driving portion 45 and the first driving portion 44 and the second driving portion 45 are connected to each other. The first driving portion 44 is connected to the first motion portion 11, and the second driving portion 45 is connected to the tensioning structure 30. Different driving states of the driving device 40 may be realized by using the first driving portion 44 and the second driving portion 45.

Referring to FIG. 7, in the first driving state, the driving unit 41 drives the sliding block 42 to drive the driving reversing block 43 to contact the first driving portion 44 and disengage from the second driving portion 45. At this time, the force generated by the driving unit 41 is transmitted to the first motion portion 11 through the driving reversing block 43 and the first driving portion 44, but not transmitted to the tensioning structure 30 through the second driving portion 45, so the first motion portion 11 will move prior to the second motion portion 12.

Referring to FIG. 7, in the second driving state, the driving unit 41 drives the sliding block 42 to drive the driving reversing block 43 to contact the second driving portion 45 and disengage from the first driving portion 44. At this time, the force generated by the driving unit 41 is transmitted to the tensioning structure 30 through the driving reversing block 43 and the second driving portion 45, but not transmitted to the first motion portion 11 through the first driving portion 44, so the tensioning structure 30 will transmit the force to the second motion portion 12 first to make the second motion portion 12 move prior to the first motion portion 11.

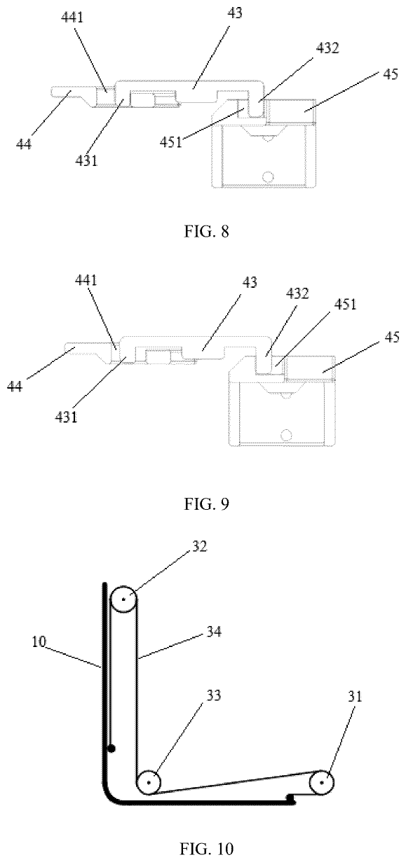

In the embodiment of the present application, referring to FIG. 8 and FIG. 9, the driving reversing block 43 includes a first contact portion 431 and a second contact portion 432, both of which are hook-and-claw structures extending from the driving reversing block 43. It can be understood that the first contact portion 431 extends towards the first driving portion 44 and the second contact portion 432 extends towards the second driving portion 45. Meanwhile, the first driving portion 44 is provided with a first groove 441, and the second driving portion 45 is provided with a second groove 451. The first contact portion 431 is located in the first groove 441, and the second contact portion 432 is located in the second groove 451.

Referring to FIG. 8, in the first driving state, the driving unit 41 exerts a force on the sliding block 42, so that the sliding block 42 drives the first contact portion 431 of the driving reversing block 43 to contact an inner wall of the first groove 441, and the second contact portion 432 is separated from an inner wall of the second groove 451. That is to say, the driving reversing block 43 is connected to the first driving portion 44 at this time, but not connected to the second driving portion 45, thus enabling the driving reversing block 43 to transfer force to the first driving portion 44 and the first motion section 11.

Referring to FIG. 9, in the second driving state, the driving unit 41 exerts a force on the sliding block 42, so that the sliding block 42 drives the second contact portion 432 of the driving reversing block 43 to contact the inner wall of the second groove 451, and the first contact portion 431 is separated from the inner wall of the first groove 441, that is, the driving reversing block 43 is connected to the second driving portion 45, but not connected to the first driving portion 44, thus enabling the driving reversing block 43 to transfer force to the second driving portion 45 and the tensioning structure 30.

It should be noted that the first contact portion 431 is in contact the inner wall of the first groove 441, which can also be understood as that a hook of the first contact portion 431 hooks the first driving portion 44, thus realizing the transmission of force; Similarly, the second contact portion 432 is in contact the inner wall of the second groove 451, which can also be understood as that the hook of the second contact portion 432 hooks the second driving portion 45, thus realizing the transmission of force.

Therefore, through cooperation of the driving reversing block 43, the first driving portion 44 and the second driving portion 45, it is realized that the driving device 40 may drive the first motion portion 11 or the second motion portion 12 to move prior to each other in the first driving state and the second driving state respectively, so that the flexible display portion 10 may always exert pressure on the support shaft 15, thereby reducing the arching phenomenon of the flexible display portion 10 and improving the user experience.

In one embodiment, referring to FIG. 6, the driving unit 41 may include a fixed sliding groove 411 and a motor 412 disposed at one end of the fixed sliding groove 411. Among them, the fixed sliding groove 411 may be fixed in the accommodating structure 20, and the fixed sliding groove 411 extends along the first direction X. An output end of the motor 412 is fixedly connected to a lead screw 413, and the lead screw 413 is located in the fixed sliding groove 411 and extends along a length direction of the fixed sliding groove 411. Meanwhile, the sliding block 42 is slidably connected in the fixed sliding groove 411, and the sliding block 42 is threadedly engaged with the lead screw 413.

In this way, when the motor 412 drives the lead screw 413 to rotate, because the sliding block 42 is located in the fixed sliding groove 411, the sliding block 42 cannot rotate with the lead screw 413, and at the same time, the sliding block 42 is threadedly engaged with the lead screw 413, so that the sliding block 42 will move on the lead screw 413 along the length direction of the lead screw 413, so that the sliding block 42 may drive the driving reversing block 43 to move.

In one embodiment, as shown in FIG. 5, the first motion portion 11 is a plate structure, and at the same time, the first fixing portion 13 is provided with guide rails 131 on both sides of the first motion portion 11, the guide rails 131 extend along the first direction X, and both sides of the first motion portion 11 are slidably connected in the two guide rails 131. In this way, the first motion portion 11 may slide on the first fixing portion 13.

In one embodiment, referring to FIG. 4, the second fixing portion 14 and the second motion portion 12 are both in a shape of comb teeth. Specifically, the second fixing portion 14 includes a plurality of first comb teeth 141, and a first accommodating groove 142 is formed between two adjacent first comb teeth 141. It can be understood that the first comb teeth 141 extend along the second direction Y; Meanwhile, the second motion portion 12 includes a plurality of second comb teeth 121, and a second accommodating groove 122 is formed between two adjacent second comb teeth 121. Among them, the first comb teeth 141 are slidably connected in the second accommodating groove 122, and the second comb teeth 121 are slidably connected in the first accommodating groove 142. In this way, the second motion portion 12 may slide on the second fixing portion 14, and the flexible display portion 10 has a supporting structure behind it no matter whether the flexible display portion 10 is in the ascending state or the descending state, thus ensuring the display effect of the flexible display portion 10.

It should be noted that the second motion portion 12 has two more second comb teeth 121 than the second fixing portion 14, and these two second comb teeth 121 are located on both sides of the second fixing portion 14 respectively. Moreover, the second accommodating groove 122 may not completely penetrate the second motion portion 12, but the first accommodating groove 142 needs to completely penetrate the second fixing portion 14.

In addition, as shown in FIG. 4, in one embodiment, a plurality of mounting grooves 1411 may be formed in the first comb teeth 141, and a magnetic member (not shown in the figure) is arranged in each mounting groove 1411. These magnetic members can exert an attractive force on the flexible display section 10, enabling the flexible display portion 10 to attach to the second fixing section 14 and further reducing the arching phenomenon of the flexible display section 10.

In the embodiment of the present application, the mounting groove 1411 is configured as a strip shape and extends along the second direction Y. In other embodiments, the mounting groove 1411 may also be a circle, a square, a polygon, or other shapes.

In the related art, service life of the tensioning structure used in the L-shaped vehicle-mounted display device is also poor, which leads to the service life of the vehicle-mounted display device being affected.

In order to prolong the service life of the vehicle-mounted display device, the embodiment of the present application also provides a vehicle-mounted display device, in which the tensioning structure 30 includes at least two groups of tensioning members.

Specifically, referring to FIG. 5, the tensioning structure 30 includes two groups of tensioning members, and the two groups of tensioning members are symmetrically distributed.

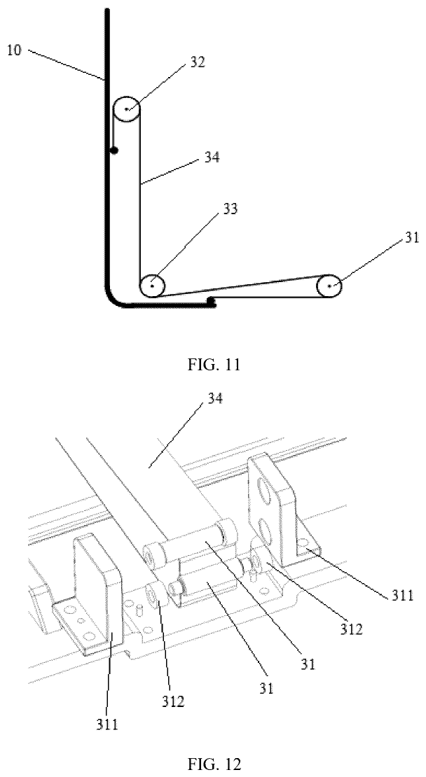

Referring to FIG. 10 and FIG. 11, the tensioning member includes a first reversing roller 31, a second reversing roller 32, a third reversing roller 33 and a tensioning belt 34. Among then, the first reversing roller 31 is rotatably connected to the first fixing portion 13, the second reversing roller 32 is rotatably connected to the second fixing portion 14, and the third reversing roller 33 is rotatably connected to the support shaft 15. One end of the tension belt 34 is fixedly connected to the first motion portion 11, and then the tension belt 34 sequentially bypasses the first reversing roller 31, the third reversing roller 33 and the second reversing roller 32, and then is fixedly connected to the second motion portion 12. (The first motion portion 11 and the second motion portion 12 are not shown in FIG. 10 and FIG. 11)

It should be noted that the driving device 40 needs to drive the first motion portion 11 or the second motion portion 12 to move first in different driving states, so the end of the tension belt 34 originally connected to the first motion portion 11 is not directly connected to the first motion portion 11. In the embodiment of the present application, as shown in FIG. 5, the end of the tension belt 34 is fixedly connected to the first driving portion 44, and at the same time the tension belt 34 is fixedly connected to the second driving portion 45. In this way, the driving unit 41 may use the first driving portion 44 to drive the first motion section 11 to move and enable the tensioning structure 30 to function. The driving unit 41 may also use the second driving portion 45 to drive the second motion portion 12 to move through the tensioning structure 30. It can also be understood that the tension belt 34 is connected to the second driving portion 45, and the first driving portion 44 and the second driving portion 45 are also connected through the tension belt 34.

Meanwhile, in this embodiment, a material of the tension belt 34 is polyimide. Using the tension belt 34 made of polyimide may prolong the service life of the tensioning structure 30, thus improving the service life of the vehicle-mounted display device.

Referring to FIG. 12, the first fixing portion 13 is provided with bearing mounting seats 311 on both sides of the first reversing roller 31, and the first bearing 312 is fixedly connected to the bearing mounting seats 311, and the first reversing roller 31 is rotatably connected to the bearing mounting seats 311 through the first bearing 312. Another group of first reversing rollers 31 are arranged between the bearing mounting seats 311 on both sides, and the tension belt 34 is sequentially wound around the two first reversing rollers 31. The two first reversing rollers 31 may ensure that the tensioning belt 34 extends along the first direction X, reducing the occurrence of the tensioning belt 34 tilting.

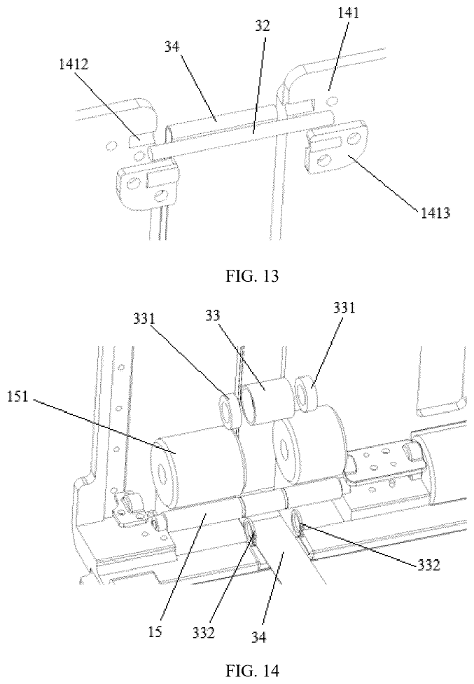

Referring to FIG. 13, the second reversing roller 32 is located between two adjacent first comb teeth 141, and at a position of the second reversing roller 32, the second motion portion 12 is provided with an opening penetrating through the second motion portion 12. Among them, the first comb tooth 141 is provided with a groove, and the end of the second reversing roller 32 is located in the groove. The first comb tooth 141 is also provided with a pressing block 1413 at a position of the groove, and the pressing block is fixedly connected to the second comb tooth 121 through a screw and restricts the end of the second reversing roller 32 in the groove.

Referring to FIG. 14, the third reversing roller 33 is rotatably arranged on the support shaft 15, but since the flexible display portion 10 also needs to contact the support shaft 15, in order to avoid interference, in the embodiment of the present application, a sleeve shaft 151 is arranged on the support shaft 15, the sleeve shaft 151 is fixedly connected to the support shaft 15, and a diameter of the sleeve shaft 151 is larger than a diameter of the third reversing roller 33, and then by allowing the flexible display portion 10 to contact the sleeve shaft 151, interference between the flexible display portion 10 and the tension belt 34 may be avoided.

The two ends of the third reversing roller 33 are provided with second bearings 331, the second bearings 331 are sleeved on the support shaft 15, and the third reversing roller 33 may be rotatably connected to the support shaft 15 through the second bearings 331, and rotation of the third reversing roller 33 will not affect rotation of the support shaft 15. At the same time, the support shaft 15 is also provided with limit clamp springs 332 at both ends of the third reversing roller 33, and the limit clamp springs 332 may limit axial movement of the third reversing roller 33 on the support shaft 15.

Referring to FIG. 17, the tensioning member further includes a fixing member 36, the fixing member 36 is arranged at an end of the tensioning belt 34 and configured to connect the end of the tensioning belt 34 to the first motion portion 11 or the second motion portion 12.

Specifically, the fixing member 36 may include a fixing pressure plate 361, and an opening is formed in the fixing pressure plate 361. When fixing the tension belt 34, the tension belt 34 is located between the fixing pressure plate 361 and a position to be fixed. Illustratively, in the embodiment of the present application, the tension belt 34 is connected to the first driving portion 44, so the tension belt 34 is located between the fixing pressure plate 361 and the first driving portion 44, and the fixing pressure plate 361 is connected to the first tension belt 34 by screws, thereby realizing fixation of the tension belt 34. The screws may or may not pass through the tension belt 34. At the same time, a fixing groove 362 may be arranged at the position to be fixed, such as at a position on the first driving portion 44. A size of the fixing groove 362 is adapted to a size of the fixing pressure plate 361, and the fixing pressure plate 361 is located in the fixing groove 362, so that the position of the fixing pressure plate 361 may be better limited by the fixing groove 362.

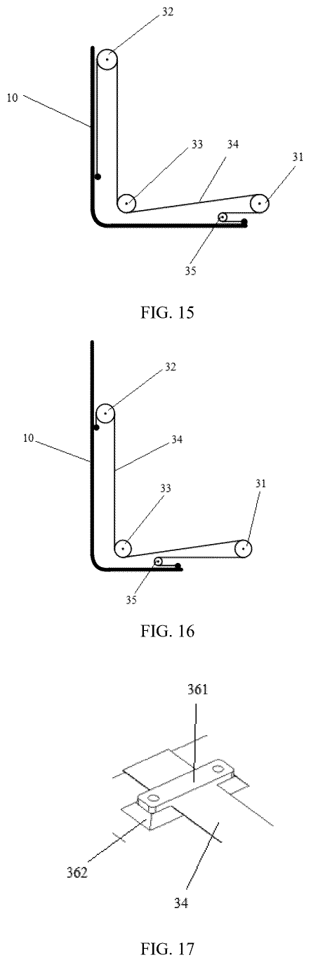

Referring to FIG. 15 and FIG. 16, the tensioning member may further include a movable roller 35, the movable roller 35 is arranged on the first motion portion 11, and the tension belt 34 is wound around the movable roller 35.

It can be understood that in the embodiment of the present application, the movable roller 35 is arranged on the first driving portion 44, and the tension belt 34 bypasses the first reversing roller 31 after bypassing the movable roller 35, so that the flexible display portion 10 may be tensioned in the descending state by using the movable roller 35.

In one embodiment, the vehicle-mounted display device may further include a control unit connected to the driving device 40, and the control unit may control the driving device 40 to switch to the first driving state and the second driving state. For example, when the flexible display portion 10 needs to be switched from the descending state to the ascending state, the control unit controls the driving device 40 to move the flexible display portion 10 in the second driving state; When the flexible display portion 10 needs to be switched from the ascending state to the descending state, the control unit controls the driving device 40 to move the flexible display portion 10 in the first driving state.

In one embodiment, the vehicle-mounted display device may further include a display unit connected to the flexible display portion 10, and the display unit is configured to control the flexible display portion 10 to emit light to display image content. The display unit may include a control circuit board, a control chip, and the like.

The present application also provides a state switching method for the vehicle-mounted display device provided in any of the above embodiments, including:
receiving a state switching instruction;
in response to an indication of the state switching instruction, switching states of the flexible display portion from an ascending state to a descending state, and driving the first motion portion to move prior to the second motion portion by the driving device, so that the first motion portion drives the second motion portion to move through the flexible display portion;
in response to the indication of the state switching instruction, switching the states of the flexible display portion from a descending state to an ascending state, and driving the second motion portion to move prior to the first motion portion through the tensioning structure, so that the second motion portion drives the first motion portion to move through the flexible display portion.

It should be noted that all the embodiments in this specification are described in a progressive way, and each embodiment focuses on the differences from other embodiments, so it is only necessary to refer to the same and similar parts of each embodiment.

It should also be noted that in this paper, the terms “center”, “upper”, “lower”, “left”, “right”, “vertical”, “horizontal”, “inner” and “outer” indicate the orientation or position relationship based on the figure, which is only for the convenience of describing the present application and simplifying the description, and is not indicative or implied. Moreover, relational terms such as “first” and “second” are only used to distinguish one entity or operation from another entity or operation, and do not necessarily require or imply the existence of any such actual relationship or order between these entities or operations, nor can they be understood as indicating or implying relative importance. Moreover, the terms “including”, “containing” or any other variation thereof are intended to cover non-exclusive inclusion, so that a process, method, article or terminal device including a series of elements includes not only those elements, but also other elements not explicitly listed, or elements inherent to such process, method, article or terminal device. Without more restrictions, the element defined by the sentence “including one . . . ” does not exclude that there are other identical elements in the process, method, article or terminal device including the element.

The technical solutions provided by the present application have been introduced in detail above, and the principle and implementation of the present application have been expounded with specific examples in this specification. The descriptions of the above examples are only used to help understand the present application, and the contents of this specification should not be understood as limitations to the present application. At the same time, according to the present application, there will be different forms of changes in the specific implementation and application scope for persons skilled in the art. It is unnecessary and impossible to exhaust all the implementation here, and the obvious changes or changes arising from this are still within the protection scope of the present application.

1. A vehicle-mounted display device, comprising:
a flexible display portion;
a first motion portion and a second motion portion, wherein the first motion portion and the second motion portion are respectively connected to two sides of the flexible display portion, and a plane where the first motion portion is located intersects with a plane where the second motion portion is located;
a tensioning structure arranged between the first motion portion and the second motion portion; and
a driving device configured to drive the first motion portion and the second motion portion to move relatively;
wherein the driving device is configured to:
in a first driving state, drive the first motion portion to move prior to the second motion portion, so that the first motion portion drives the second motion portion to move through the flexible display portion; and
in a second driving state, drive the second motion portion to move prior to the first motion portion through the tensioning structure, so that the second motion portion drives the first motion portion to move through the flexible display portion.

2. The vehicle-mounted display device according to claim 1, wherein:
the driving device comprises a driving unit and a sliding block arranged on the driving unit, and a driving reversing block is arranged on the sliding block;
the driving unit is configured to drive the sliding block and the driving reversing block to move in a first direction;
the driving device further comprises a first driving portion and a second driving portion that are connected to each other, wherein the first driving portion is connected to the first motion portion, and the second driving portion is connected to the tensioning structure;
wherein, in the first driving state, the driving unit drives the sliding block so that the driving reversing block contacts the first driving portion and disengages from the second driving portion; and
in the second driving state, the driving unit drives the sliding block so that the driving reversing block contacts the second driving portion and disengages from the first driving portion.

3. The vehicle-mounted display device according to claim 2, wherein:
the driving reversing block comprises a first contact portion and a second contact portion;
the first driving portion is provided with a first groove, the second driving portion is provided with a second groove, the first contact portion is located in the first groove, and the second contact portion is located in the second groove;
wherein, in the first driving state, the driving unit drives the sliding block so that the first contact portion contacts an inner wall of the first groove and the second contact portion disengages from an inner wall of the second groove; and
in the second driving state, the driving unit drives the sliding block so that the second contact portion contacts the inner wall of the second groove and the first contact portion disengages from the inner wall of the first groove.

4. The vehicle-mounted display device according to claim 2, wherein:
the driving unit comprises a fixed sliding groove and a motor arranged at one end of the fixed sliding groove;
the fixed sliding groove extends along the first direction, and an output end of the motor is provided with a lead screw, and the lead screw is located in the fixed sliding groove and extends along a length direction of the fixed sliding groove; and
the sliding block is slidably connected in the fixed sliding groove, and the sliding block is threadedly engaged with the lead screw.

5. The vehicle-mounted display device according to claim 1, wherein the vehicle-mounted display device further comprises:
a mounting portion, comprising a first fixing portion and a second fixing portion that are connected to each other; wherein
the first motion portion is slidably connected to the first fixing portion along the first direction, and the second motion portion is slidably connected to the second fixing portion along a second direction;
the first direction and the second direction are perpendicular to each other.

6. The vehicle-mounted display device according to claim 5, wherein:
a side of the second fixing portion away from the second motion portion is rotatably connected to a plurality of support shafts, and the flexible display portion contacts the plurality of support shafts.

7. The vehicle-mounted display device according to claim 6, wherein:
the tensioning structure comprises at least two groups of tensioning members;
each of the tensioning members comprises a first reversing roller, a second reversing roller, a third reversing roller and a tensioning belt, wherein the first reversing roller is arranged on the first fixing portion, the second reversing roller is arranged on the second fixing portion, the third reversing roller is rotatably arranged on a support shaft of the plurality of support shafts, one end of the tensioning belt is fixedly connected to the first motion portion, and the tensioning belt sequentially bypasses the first reversing roller, the third reversing roller and the second reversing roller, and is fixed connected to the second motion portion.

8. The vehicle-mounted display device according to claim 7, wherein:
a material of the tension belt comprises polyimide.

9. The vehicle-mounted display device according to claim 7, wherein:
the support shaft is fixedly connected to a plurality of sleeve shafts, diameters of the plurality of sleeve shafts are larger than a diameter of the third reversing roller, the flexible display portion contacts the plurality of sleeve shafts, and the third reversing roller is independent of the plurality of sleeve shafts.

10. The vehicle-mounted display device according to claim 7, wherein:
two ends of the third reversing roller are provided with second bearings, the second bearings are sleeved on the support shaft, and the support shaft is provided with limit clamp springs at both ends of the third reversing roller.

11. The vehicle-mounted display device according to claim 7, wherein:
the first fixing portion is provided with bearing mounting seats at both sides of the first reversing roller, and first bearings are fixedly arranged on the bearing mounting seats, and the first reversing roller is rotatably connected to the bearing mounting seats through the first bearings;
a fourth reversing roller is further arranged between the bearing mounting seats, and the tension belt is sequentially wound around the first reversing roller and the fourth reversing roller.

12. The vehicle-mounted display device according to claim 7, wherein:
the tensioning member further comprises a movable roller, the movable roller is arranged on the first motion portion, and the tensioning belt is wound around the movable roller.

13. The vehicle-mounted display device according to claim 7, wherein:
the tensioning member further comprises a fixing member arranged at an end of the tensioning belt and the fixing member is configured to connect the end of the tensioning belt to the first motion portion or the second motion portion.

14. The vehicle-mounted display device according to claim 5, wherein:
the first fixing portion is provided with two guide rails on both sides of the first motion portion, and the guide rails extend along the first direction, and both sides of the first motion portion are respectively slidably connected in the two guide rails.

15. The vehicle-mounted display device according to claim 5, wherein:
the second fixing portion comprises a plurality of first comb teeth, and a first accommodating groove is formed between two adjacent first comb teeth;
the second motion portion comprises a plurality of second comb teeth, and a second accommodating groove is formed between two adjacent second comb teeth;
the first comb teeth are slidably connected in the second accommodating groove, and the second comb teeth are slidably connected in the first accommodating groove.

16. The vehicle-mounted display device according to claim 15, wherein:
the first comb teeth are provided with a plurality of mounting grooves, and magnetic members are arranged in the plurality of mounting grooves.

17. The vehicle-mounted display device according to claim 16, wherein:
the plurality of mounting groove are configured as a strip shape and extend along the second direction.

18. The vehicle-mounted display device according to claim 5, wherein the vehicle-mounted display device further comprises:
an accommodating structure, wherein the mounting portion, the driving device and the tensioning structure are all located in the accommodating structure.

19. The vehicle-mounted display device according to claim 5, wherein the vehicle-mounted display device further comprises:
a control unit, connected to the driving device and configured to control the driving device to switch to the first driving state or the second driving state.

20. (canceled)

21. A state switching method for the vehicle-mounted display device according to claim 1, comprising:
receiving a state switching instruction;
in response to an indication of the state switching instruction, switching states of the flexible display portion from an ascending state to a descending state, and driving the first motion portion to move prior to the second motion portion by the driving device, so that the first motion portion drives the second motion portion to move through the flexible display portion;
in response to the indication of the state switching instruction, switching the states of the flexible display portion from the descending state to the ascending state, and driving the second motion portion to move prior to the first motion portion through the tensioning structure, so that the second motion portion drives the first motion portion to move through the flexible display portion.
